(19) United States
(12) Patent Application Publication
(10) Pub. No.: US 2026/0261820 A1
(43) Pub. Date: Sep. 3, 2026

(54) DEVICE POSITIONING METHOD, SYSTEM, AND APPARATUS, COMMUNICATION DEVICE, AND STORAGE MEDIUM

(71) Applicant: Beijing Xiaomi Mobile Software Co., Ltd., Beijing (CN)

(72) Inventor: Jinhua WU, Beijing (CN)

(21) Appl. No.: 18/995,697

(22) PCT Filed: Jul. 29, 2022
(86) PCT No.: PCT/CN2022/109175

§ 371 Date: Jan. 16, 2025

(51) Int. Cl. H04W 4/021; H04W 4/02; H04W 4/029; H04W 84/18

(52) U.S. Cl. CPC H04W 4/021; H04W 4/025; H04W 4/029; H04W 84/18

(57) ABSTRACT

A method (200, 300) and system (100, 300) for monitoring a container or other object (T, 30, 80) comprises an RFID device (T, 30), e.g., interior the container, transmitting (225) messages including unique identifying information, and a receiving device (30, TS) exterior the object (T, 30, 80) receiving, storing, and/or relaying (235-240) messages received from the RFID device (T, 30). Receptions (235) of messages transmitted by the RFID device (T, 30) when the object (T, 30, 80) is closed and when it is not closed are processed (245-285) to provide an indication of the location of the object (T, 30, 80) and/or whether the object (T, 30, 80) has or has not been opened. Messages may include power level codes and be transmitted (225-230) at more than one power level, and may be processed (245-285) for monitoring, locating and/or tracking (245-290, 300) the object (T, 30, 80).

### CROSS REFERENCE TO RELATED APPLICATIONS

This application is a US National Phase of International Application No. PCT/CN2022/109175, filed on Jul. 29, 2022, the entire content of which is incorporated herein by reference.

### TECHNICAL FIELD

The present disclosure relates to, but is not limited to, the field of wireless communication technologies, in particular to a method, system and apparatus for positioning a device, a communication device and a storage medium.

### BACKGROUND

In the related art, location information of a user equipment (UE) in a network can be determined by obtaining standard format information such as geographic coordinate information, etc., so that the location information can be provided to a subscriber, a management entity (ME), a network operator, a service provider, or a public land mobile network (PLMN), etc., for tracking or positioning. However, an internet of things (IoT) device does not have the ability to provide the location information and thus cannot be used for tracking or positioning. For example, the IoT device cannot support the tracking or positioning of packages or goods in logistics.

### SUMMARY

According to a first aspect of the embodiments of the present disclosure, there is provided a method for positioning a device, performed by a first network function and including:
in response to receiving a location request for an internet of things (IoT) device, returning location information of a user equipment (UE) bound to the IoT device, where the UE is located within a preset range of the IoT device.

According to a second aspect of the embodiments of the present disclosure, there is provided a method for positioning a device, performed by a second network function and including:
in response to receiving a location information obtaining request, from a first network function, for a UE bound to an internet of things (IoT) device to be located, returning location information of the UE, where the UE is located within a preset range of the IoT device.

According to a third aspect of the embodiments of the present disclosure, there is provided a method for positioning a device, performed by a third network function and including:
sending a location request for an internet of things (IoT) device, and receiving location information of a user equipment (UE) bound to the IoT device returned by a first network function, where the UE is located within a preset range of the IoT device.

According to a fourth aspect of the embodiments of the present disclosure, there is provided a system for positioning a device, including: an internet of things (IoT) device, a user equipment (UE) and a network function set.

The IoT device is configured to establish a connection with the UE.

The UE is configured to send a connection report to the network function set after establishing a connection with the IoT device, and the connection report indicates at least a device identifier of the IoT device with which the UE establishes a connection.

The network function set is configured to establish, based on the connection report, a binding relationship between the UE and the IoT device, and to determine, based on a location request for the IoT device, location information of the UE bound to the IoT device, where the UE is located within a preset range of the IoT device, or the IoT device is located within a preset range of the UE.

According to a fifth aspect of the embodiments of the present disclosure, there is provided a communication device, including: a processor; and a memory storing programs executable by the processor, where the programs, when executed by the processor, cause the processor to perform the method for positioning the device of the first, second, or third aspect.

According to a sixth aspect of the embodiments of the present disclosure, there is provided a computer storage medium, storing executable programs thereon, where the executable programs, when executed by a processor, cause the processor to perform the method for positioning the device of the first, second, or third aspect.

It is to be understood that the above general descriptions and the below detailed descriptions are merely exemplary and explanatory, and are not intended to limit the present disclosure.

### BRIEF DESCRIPTION OF THE DRAWINGS

The accompanying drawings herein, which are incorporated in and constitute a part of the present description, illustrate examples consistent with the present disclosure and serve to explain the principles of the present disclosure together with the description.

FIG. 1 is a schematic structural diagram illustrating a wireless communication system according to an embodiment of the present disclosure.

FIG. 2 is a flowchart illustrating a method for positioning a device according to an embodiment of the present disclosure.

FIG. 3 is a flowchart illustrating a method for positioning a device according to another embodiment of the present disclosure.

FIG. 4 is a flowchart illustrating a method for positioning a device according to yet another embodiment of the present disclosure.

FIG. 5 is a flowchart illustrating a method for positioning a device according to still another embodiment of the present disclosure.

FIG. 6 is a flowchart illustrating a method for positioning a device according to still another embodiment of the present disclosure.

FIG. 7 is a schematic diagram illustrating an architecture of a system for positioning a device according to an embodiment of the present disclosure.

FIG. 8 is a flowchart illustrating a method for positioning a device according to still another embodiment of the present disclosure.

FIG. 9 is a schematic structural diagram illustrating an apparatus for positioning a device according to an embodiment of the present disclosure.

FIG. 10 is a schematic structural diagram illustrating an apparatus for positioning a device according to another embodiment of the present disclosure.

FIG. 11 is a schematic structural diagram illustrating an apparatus for positioning a device according to yet another embodiment of the present disclosure.

FIG. 12 is a schematic structural diagram illustrating a terminal according to an embodiment of the present disclosure.

FIG. 13 is a schematic structural diagram illustrating a communication device according to an embodiment of the present disclosure.

### DETAILED DESCRIPTION OF THE EMBODIMENTS

Examples will be described in detail herein, with the illustrations thereof represented in the drawings. Where the following description relates to the drawings, unless otherwise indicated, the same numerals in different drawings represent the same or similar elements. Implementations described in the following examples do not represent all implementations consistent with the present disclosure. On the contrary, they are examples of an apparatus and a method consistent with some aspects of the present disclosure described in detail in the appended claims.

The terms used in the present disclosure are for the purpose of describing a particular example only, and are not intended to limit the present disclosure. As used herein, the singular forms “a”, “said” and “the” are intended to include the plural forms as well, unless the context clearly indicates otherwise. It will also be understood that as used herein, the term “and/or” is and includes any or all combinations of one or more of the associated listed items.

It is to be understood that although different information may be described using the terms such as “first,” “second,” “third,” etc. in the present disclosure, the information should not be limited to these terms. These terms are used only to distinguish the same type of information from each other. For example, the first information may also be referred to as the second information without departing from the scope of the present disclosure, and similarly, the second information may also be referred to as the first information. Depending on the context, as used herein, the wording “if” may be interpreted as “while . . . ” or “when . . . ” or “in response to a determination”.

FIG. 1 is a schematic structural diagram illustrating a wireless communication system according to an embodiment of the present disclosure. As shown in FIG. 1, the wireless communication system is a communication system based on the cellular mobile communication technology, which may include a plurality of terminals 11 and a plurality of access devices 12.

The terminal 11 may be a device that provides voice and/or data connectivity to users. The terminal 11 can communicate with one or more core networks via a radio access network (RAN). The terminal 11 can be an IoT terminal, such as a sensor device, a mobile phone (or a “cellular” phone) and a computer with an IoT terminal. For example, it can be a fixed, portable, pocket-sized, handheld, computer-built or on-board device. For example, a station (STA), a subscriber unit, a subscriber station, a mobile station, a remote station, an access point, a remote terminal, an access terminal, a user terminal, a user agent, a user device or a user equipment (UE). Alternatively, the terminal 11 may be a device of an unmanned aerial vehicle. Alternatively, the terminal 11 may also be an on-board device, for example, a driving computer with wireless communication function, or a wireless communication device externally connected to the driving computer. Alternatively, the terminal 11 may also be a roadside device, such as a street lamp, a signal lamp or other roadside device with wireless communication function.

The access device 12 may be a network device in a wireless communication system. The wireless communication system can be the 4th (4G) generation mobile communication system, also known as long term evolution (LTE) system. Alternatively, the wireless communication system can also be a 5G system, also known as a new radio (NR) system or a 5G NR system. Alternatively, the wireless communication system can also be a next generation system of the 5G system. The access network in the 5G system can be called a new generation-radio access network (NG-RAN). Or, a machine type communication (MTC) system.

The access device 12 may be an evolved access device (eNB) adopted in the 4G system. Alternatively, the access device 12 may also be an access device (gNB) adopting a centralized and distributed architecture in the 5G system. When the access device 12 adopts a centralized and distributed architecture, the base station 12 usually includes a central unit (CU) and at least two distributed units (DUs). The centralized unit is provided with a protocol stack of packet data convergence protocol (PDCP) layer, radio link control (RLC) layer and media access control (MAC) layer. The distributed unit is provided with a physical (PHY) layer protocol stack. The embodiments of the present disclosure does not limit the specific implementation of the access device 12.

A wireless connection can be established between the access device 12 and the terminal 11 through a wireless air interface. In different embodiments, the wireless air interface is based on the fourth generation (4G) mobile communication network technology standard. Alternatively, the wireless air interface is based on the fifth generation (5G) mobile communication network technology standard, for example, the wireless air interface is a new radio. Alternatively, the wireless air interface can also be a wireless air interface based on the technical standard of the next generation mobile communication network of 5G.

In some embodiments, the wireless communication system may further include a network management device 13. A plurality of access devices 12 are respectively connected with a network management device 13. The network management device 13 may be a core network device in a wireless communication system. For example, the network management device 13 may be a mobility management entity (MME) in an evolved packet core (EPC). Alternatively, the network management device can also be other core network devices, such as serving gateway (SGW), public data network gateway (PGW), policy and charging rules function (PCRF) or home subscriber server (HSS). The embodiment of the present disclosure does not limit the implementation form of the network management device 13.

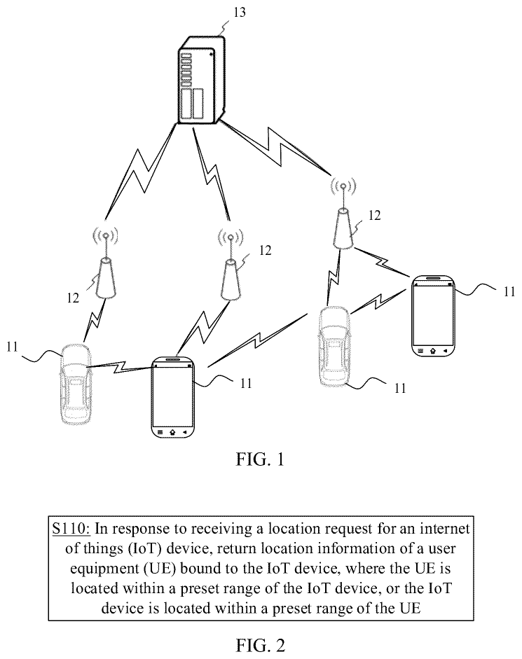

As shown in FIG. 2, an embodiment of the present disclosure, there is provided a method for positioning a device, which is performed by a first network function and includes the following step S110.

At step S110, in response to a location request for an internet of things (IoT) device being received, location information of a user equipment (UE) bound to the IoT device is returned, where the UE is located within a preset range of the IoT device, or the IoT device is located within a preset range of the UE.

In an embodiment of the present disclosure, the IoT device may be a device that accesses the IoT, for example, it may be a radio frequency identification (RFID) based IoT device. For example, in a logistics and transportation scenario, the IoT device may be an electronic tag or a sensor device, etc., for identifying different packages or goods, etc. For example, the IoT device may be mounted on the surface or inside of the packages or goods.

The UE may be a UE which is bound to at least one IoT device to manage the IoT device. For example, in a logistics and transportation scenario, the UE may be a device loaded in a container or vehicle in which the packages or goods are located, for example, a smart device on the vehicle or a handheld device of an operator in the vehicle, etc. The UE bound to the IoT device may be a neighboring UE connected to the IoT device, where the neighboring UE may be a UE located within a preset range of the IoT device, or the IoT device is located within a preset range of the neighboring UE.

In an embodiment, the first network function may be a unified data management (UDM) function, and the first network function may be communicatively coupled with an access and mobility management function (AMF) associated with the UE, such that the location of the UE may be obtained via the AMF to obtain the location information of the UE.

In an embodiment, when the UE is located within a preset range of the IoT device, or when the IoT device is located within a preset range of the UE, it can be considered that the UE is located in a neighboring location of the IoT device, the UE is connected to the IoT device, and a binding relationship is established.

For example, the UE receives a connection request from the IoT device within the preset range, or the IoT device sends a connection request to the UE within the preset range, etc., and the UE establishes a connection with the IoT device.

The preset range may be an area range formed within a certain distance, for example, the preset range of the UE may be a circular range formed with the UE as the center of the circle and a radius of the preset distance.

In an embodiment, the UE establishes a connection with the IoT device by a wired connection, or a side line link based on a direct connection interface (PC5), or other wireless connection technology. For example, the connection is established by passive IoT or environmental IoT based on the 3rd generation partnership project (3GPP), or the connection is established by Bluetooth, wireless fidelity (WIFI) or RFID.

In an embodiment, the establishment of the binding relationship between the UE and the IoT device may be based on the UE identifier of the UE and the device identifier of the IoT device, and the establishment of the binding relationship between the UE identifier and the device identifier in the first network function, so as to facilitate querying the UE identifier of the neighboring UE bound to the IoT device to be located.

The UE identifier may be a generic public subscription identifier (GPSI) of the UE, or a subscriber permanent identifier (SUPI), or a flag bit indicating the identity of the UE. The device identifier can be the GPSI of the IoT device, or a flag bit indicating the identity of the IoT device.

In an embodiment, receiving the location request for the IoT device may be receiving the location request for the IoT device sent by an application function (AF), such as receiving the location request for the IoT device sent by an AF via a network exposure function (NEF).

In an embodiment, returning the location information of the UE bound to the IoT device may be returning the location information of the UE bound to the IoT device to the AF sending the location request for the IoT device.

In one embodiment, the subscription relationship between the UE and the IoT device can be recorded in the first network function, for example, the UE subscribes to the IoT device connected with the UE, and/or the IoT device subscribes to the neighboring UE connected with the IoT device. The subscription relationship can record the UE identifier of the UE and the device identifier of the IoT device subscribed by the UE, and/or the device identifier of the IoT device and the UE identifier of the UE subscribed by the IoT device.

In an embodiment, the mapping relationship between the GPSI of the UE and the SUPI of the UE can also be recorded in the first network function. For example, after the GPSI of the UE and the SUPI of the UE are obtained, the mapping relationship between the GPSI of the UE and the SUPI of the UE can be established, so that any UE identifier of the UE bound to the IoT device can be searched efficiently and quickly.

In this way, when the IoT device needs to be located, the location information of the UE bound to the IoT device and located near the IoT device is provided, so that the location of the UE can be regarded as an approximate location of the IoT device, thus the tracking or positioning capability for the IoT device is improved. Furthermore, obtaining the location information of the UE is more convenient, the resource consumption for positioning the IoT device can be reduced, and by binding the UE and the IoT device, the positioning management capability for one or more IoT devices can be improved.

An embodiment of the present disclosure, there is provided a method for positioning a device, which is performed by the first network function and includes the following steps S121 to S123.

At step S121, in response to a location request for an IoT device being received, a device identifier of the IoT device indicated by the location request is determined.

At step S122, the location information of the UE bound to the IoT device as indicated by a binding relationship corresponding to the device identifier is obtained.

At step S123, the location information is returned, where the UE is located within a preset range of the IoT device, or the IoT device is located within a preset range of the UE.

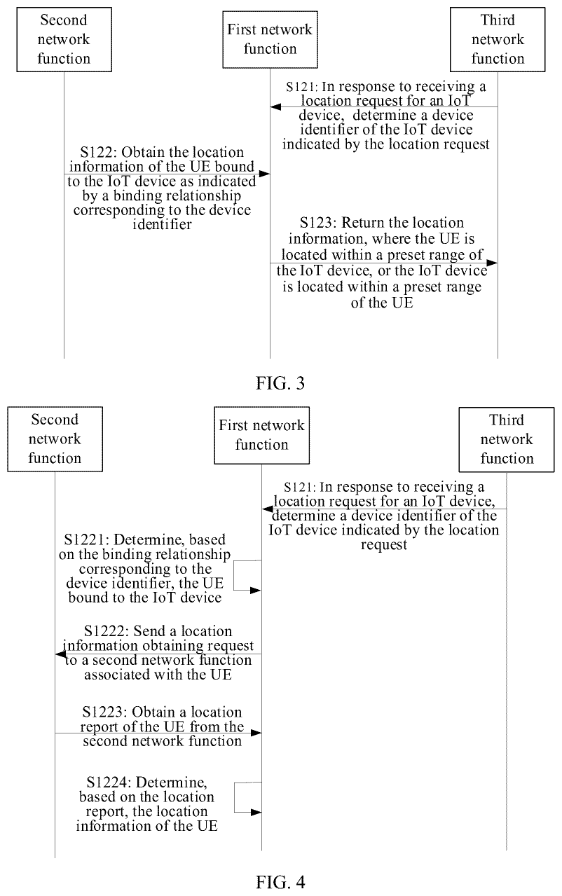

In an embodiment of the present disclosure, as shown in FIG. 3, the first network function may receive a location request sent by a third network function, such as an AF, and the first network function may obtain location information of the UE from a second network function, such as an AMF associated with the UE, and return the location information to the third network function.

In an embodiment, the location request may carry a device identifier of the IoT device to be located, such as a GPSI of the device. The location request may carry a device identifier of one or more IoT devices to be located, and the returned location information may be location information of one or more UEs bound to the one or more IoT devices.

In an embodiment, the binding relationship corresponding to the device identifier may be obtained in the first network function, for example, by querying the binding relationship recording the device identifier or associated with the device identifier in the UDM based on the device identifier. The binding relationship may record the UE identifier of the UE and the device identifier of one or more IoT devices connected to the UE.

In an embodiment, obtaining the location information of the UE bound to the IoT device as indicated by the binding relationship corresponding to the device identifier may be obtaining the location information directly from the UE bound to the IoT device as indicated by the binding relationship corresponding to the device identifier, or obtaining the location information of the UE from the AMF associated with the UE bound to the IoT device as indicated by the binding relationship corresponding to the device identifier, or obtaining the location information of the UE from a location management function (LMF) associated with the UE bound to the IoT device as indicated by the binding relationship corresponding to the device identifier, or obtaining the location information of the UE from a server or a control platform, etc. corresponding to the UE bound to the IoT device as indicated by the binding relationship corresponding to the device identifier.

In an embodiment, the obtained location information of the UE may be location information in a standard format such as geographic coordinate data, etc., or may be a location report that records UE location information and/or location relativity, e.g., the location report may record a tracking area identity (TAI) corresponding to the UE and/or a cell identity, etc., of the cell where the UE is located.

In an embodiment, obtaining the location information of the UE bound to the IoT device indicated by the binding relationship corresponding to the device identifier may be obtaining the location information of the UE by sending a location information obtaining request to a second network function such as an AMF or an LMF, etc. associated with the UE bound to the IoT device as indicated by the binding relationship corresponding to the device identifier.

The location information obtaining request can carry a UE identifier of the UE bound to the IoT device to be located.

In this way, the binding relationship established based on the device identifier of the IoT device and the UE identifier of the UE connected to the IoT device helps to more quickly and efficiently query the UE bound to the IoT device to be located,, and thus improves the efficiency of positioning the IoT device.

In some embodiments, as shown in FIG. 4, the step 122 may include steps 1221 to 1224.

At step S1221, the UE bound to the IoT device is determined based on the binding relationship corresponding to the device identifier.

At step S1222, a location information obtaining request is sent to a second network function associated with the UE.

At step S1223, a location report of the UE from the second network function is obtained.

At step S1224, the location information of the UE is determined based on the location report.

In an embodiment of the present disclosure, determining, based on the binding relationship corresponding to the device identifier, the UE bound to the IoT device may include: determining a UE identifier of the UE bound to the IoT device based on the binding relationship corresponding to the device identifier; and querying the corresponding UE based on the UE identifier. The UE identifier may include a GPSI or a SUPI of the UE, etc.

In an embodiment, determining the UE bound to the IoT device based on the binding relationship corresponding to the device identifier may include: determining the GPSI of the UE bound to the IoT device based on the binding relationship corresponding to the device identifier, and querying the corresponding UE based on the GPSI of the UE; or, determining the SUPI of the UE based on the GPSI of the UE and the mapping relationship between the GPSI and the SUPI, and querying the corresponding UE based on the SUPI of the UE.

In an embodiment, the second network function associated with the UE may be an AMF or LMF associated with the UE. The AMF or LMF associated with the UE can be an AMF or LMF that provides services to the UE. The second network function may be configured to return a location report of the corresponding UE based on the location information obtaining request. The location information obtaining request may indicate the UE from which the location information is desired to be obtained, for example, the location information obtaining request may carry a UE identifier of the UE. The second network function may be configured to obtain and send to the first network function a location report of the UE corresponding to the UE identifier.

In an embodiment, the location report may record a TAI corresponding to the UE and/or a cell identity of the cell in which the UE is located, and determining the location information of the UE based on the location report may be determining the location information of the UE based on the TAI and/or the cell identity recorded in the location report. For example, the TAI and/or the cell identity may be used as the location information of the UE, or the geographic coordinate data of the UE may be determined based on the TAI and/or the cell identity as the location information of the UE.

In some embodiments, the location report includes:
a tracking area identity (TAI) corresponding to the UE, or a cell identity corresponding to the UE.

In some embodiments, the location request for the IoT device may include:
the location request for the IoT device from a third network function.

Returning the location information includes:
returning the location information to the third network function.

In the embodiments of the present disclosure, the third network function may be an application function (AF). A device identifier of the IoT device to be located may be indicated in the location request, from the third network function, for the IoT device.

In some embodiment, the method further includes:
receiving a binding relationship update request from the second network function associated with the UE; and
binding the IoT device and the UE as indicated by the binding relationship update request.

In the embodiments of the present disclosure, the binding relationship update request may indicate the UE and the IoT device that need to be bound, for example, it may carry the UE identifier of the UE that needs to be bound and the device identifier of the IoT device. After receiving the binding relationship update request, the first network function can bind the corresponding IoT device and the UE by establishing the binding relationship between the UE identifier and the device identifier in the binding relationship update request.

In an embodiment, the UE and the IoT device that need to be bound may be a UE associated with the second network function and an IoT device connected to the UE, e.g., the binding relationship update request may carry the UE identifier of the UE and the device identifier of a plurality of IoT devices connected to the UE.

In an embodiment, the binding relationship update request may further carry a UE identifier of at least one UE associated with the second network function, and a device identifier of at least one IoT device connected to the at least one UE.

In an embodiment, the binding relationship between the IoT device and the UE is generated after binding the IoT device and the UE, and the binding relationship is saved in the first network function. For example, identifier information may be generated for the binding relationship, where the identifier information may indicate a device identifier of the IoT device included in the binding relationship. The corresponding binding relationship and the bound UE can be found more quickly based on the device identifier of the IoT device to be located.

In some embodiments, the binding relationship update request may include:
a generic public subscription identifier (GPSI) or a subscriber permanent identifier (SUPI) of the UE, and a GPSI of the IoT device.

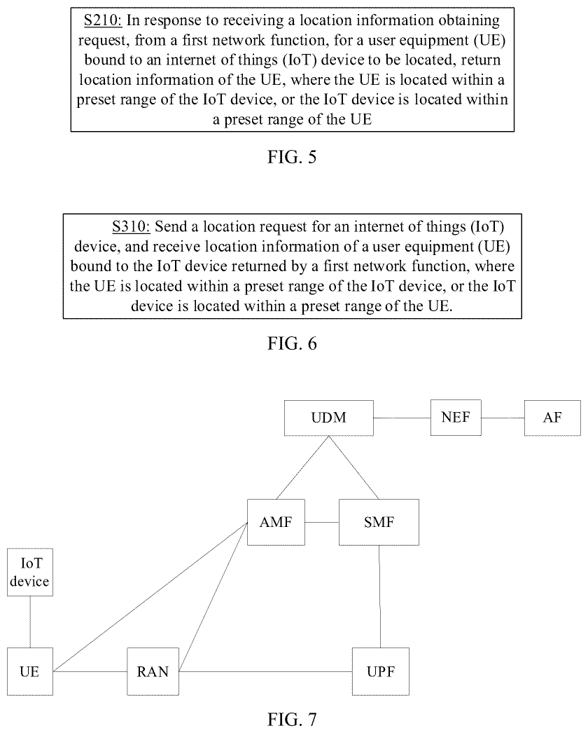

As shown in FIG. 5, an embodiment of the present disclosure, there is provided a method for positioning a device, which is performed by a second network function and includes the following step S210.

At step S210, in response to receiving a location information obtaining request, from a first network function, for a UE bound to an internet of things (IoT) device to be located, location information of the UE is returned, where the UE is located within a preset range of the IoT device, or the IoT device is located within a preset range of the UE.

In the embodiments of the present disclosure, the second network function may be, for example, an AMF or LMF associated with a UE, such as an AMF or LMF that provides services to at least one UE.

In an embodiment, the first network function may be a UDM, and the first network function may be communicatively connected to the second network function associated with the UE, such as an AMF or an LMF, so that the location information of the UE may be obtained via the second network function.

In an embodiment, when the UE is located within a preset range of the IoT device, or when the IoT device is located within a preset range of the UE, it can be considered that the UE is located in a neighboring location of the IoT device, the UE is connected to the IoT device, and a binding relationship is established.

The preset range may be an area range formed within a certain distance, for example, the preset range of the UE may be a circular range formed with the UE as the center of the circle and a radius of the preset distance.

In an embodiment, the establishment of the binding relationship between the UE and the IoT device may be based on the UE identifier of the UE and the device identifier of the IoT device, and the establishment of the binding relationship between the UE identifier and the device identifier in the first network function, so as to facilitate querying the UE identifier of the neighboring UE bound to the IoT device to be located.

The UE identifier may be a GPSI or a SUPI of the UE, or a flag bit indicating the identity of the UE. The device identifier can be the GPSI of the IoT device, or a flag bit indicating the identity of the IoT device.

In an embodiment, returning the location information of the UE may be returning the location information of the UE to the first network function sending the location information obtaining request.

In an embodiment, the second network function may obtain the location information of the UE to a radio access network (RAN), for example, the AMF obtains a location report of the UE from the RAN and returns the location report to the first network function.

In this way, when the IoT device needs to be located, the location information of the UE bound to the IoT device and located near the IoT device is provided, so that the location of the UE can be regarded as an approximate location of the IoT device, thus the tracking or positioning capability for the IoT device is improved. Furthermore, obtaining the location information of the UE is more convenient, the resource consumption for positioning the IoT device can be reduced, and by binding the UE and the IoT device, the positioning management capability for one or more IoT devices can be improved.

In some embodiments, the location information obtaining request indicates at least a UE identifier of the UE bound to the IoT device to be located.

In some embodiments, returning the location information of the UE includes:
send a location report control message of the UE to a radio access network (RAN);
receive a location report of the UE returned by the RAN based on the location report control message; and
return the location report.

In the embodiments of the present disclosure, the location report control message may instruct the RAN to provide the location report for the UE, e.g., the location report control message may indicate a UE identifier of the desired UE, and may also indicate the type and/or content of the desired location report. The type of the location report may indicate a single independent report of the cell identity of the cell in which the UE is currently located or serving the UE. The content of the location report may indicate a level of the location report, e.g. the content of the location report includes a TAI corresponding to the UE and a cell identity.

In some embodiments, the location report includes:
a tracking area identity (TAI) corresponding to the UE, or a cell identity corresponding to the UE.

In some embodiments, the location report control message indicates at least one of that:
a UE identifier of the UE;
the location report is an independent location report indicating a cell in which the UE is located; or
the location report includes at least one of: a TAI corresponding to the UE, or a cell identity corresponding to the UE.

In some embodiment, the method further includes:
in response to receiving a registration request for the UE, registering the UE;
receiving a connection report sent by the registered UE, where the connection report indicates at least a device identifier of the IoT device with which the registered UE establishes a connection; and
sending, based on the connection report, a binding relationship update request indicating the registered UE and the IoT device to a first network function.

In the embodiments of the present disclosure, the registration request may be sent by the UE to the second network function, e.g., the UE sends the registration request to the AMF. For example, the second network function may receive the registration request from the UE via the RAN.

In an embodiment, the registration request may indicate registration parameters for the UE, for example, the registration parameters may include at least one of a registration type, a subscription concealed identifier (SUCI), a globally unique temporary UE identity (GUTI), a permanent equipment identifier (PEI), or security parameters.

In an embodiment, the second network function may obtain access and mobility subscription data from the first network function, such as the UDM, as well as selection subscription data from the service management function (SMF), based on the registration request. The second network function creates a UE context for the UE after obtaining the access and mobility subscription data. After authentication and authorization of the UE, the second network function may send a prompt message to the UE to complete the UE registration.

Here, the prompt message may be a registration accept information, for example, including a GUTI and the like.

In an embodiment, receiving the connection report sent by the registered UE may be receiving the connection report sent by the registered UE via the RAN. The connection report may be sent after the UE is connected to the IoT device, for example, the connection report may be a non access stratum (NAS) message, for example, the content of the NAS message may be “connected IoT device report”, indicating that the IoT device is directly connected to the UE.

In an embodiment, the connection report may carry a device identifier of the IoT device bound to the UE, such as a GPSI of the device.

In some embodiments, the binding relationship update request includes:
a generic public subscription identifier (GPSI) or a subscriber permanent identifier (SUPI) of the registered UE, and a GPSI of the IoT device.

As shown in FIG. 6, an embodiment of the present disclosure, there is provided a method for positioning a device, which is performed by a third network function and includes the following step S310.

At step S310, in response to a location request for an internet of things (IoT) device being received, location information of a user equipment (UE) bound to the IoT device is returned, where the UE is located within a preset range of the IoT device, or the IoT device is located within a preset range of the UE.

In the embodiments of the present disclosure, the third network function may be an application function (AF). The AF may communicate with the first network function such as an AMF via a NEF.

In an embodiment, the location request may carry a device identifier of the IoT device to be located, such as a GPSI of the device. The location request may carry a device identifier of one or more IoT devices to be located, and the returned location information may be location information of one or more UEs bound to the one or more IoT devices.

In an embodiment, the binding relationship corresponding to the device identifier may be obtained in the first network function, for example, by querying the binding relationship recording the device identifier or associated with the device identifier in the UDM based on the device identifier. The binding relationship may record the UE identifier of the UE and the device identifier of one or more IoT devices connected to the UE.

In an embodiment, the location information of the UE may be location information in a standard format such as geographic coordinate data, etc., or may be a location report that records UE location information and/or location relativity, e.g., the location report may record a tracking area identity (TAI) corresponding to the UE and/or a cell identity, etc., of the cell where the UE is located.

In this way, the binding relationship established based on the device identifier of the IoT device and the UE identifier of the UE connected to the IoT device helps to more quickly and efficiently query the UE bound to the IoT device to be located,, and thus improves the efficiency of positioning the IoT device.

In some embodiments, sending the location request for the IoT device may include:
sending, by a network exposure function (NEF), the location request for the IoT device to the first network function.

In some embodiments, receiving the location information of the UE bound to the IoT device returned by the first network function includes:
receive, by a NEF, the location information of the UE bound to the IoT device returned by the first network function.

In some embodiments, the location information includes at least one of: a TAI corresponding to the UE, or a cell identity corresponding to the UE.

An embodiment of the present disclosure provides a system for positioning a device, including: an IoT device, a UE and a network function set;
the IoT device is configured to establish a connection with the UE;
the UE is configured to send a connection report to the network function set after establishing a connection with the IoT device, and the connection report indicates at least a device identifier of the IoT device with which the UE establishes a connection; and
the network function set is configured to establish, based on the connection report, a binding relationship between the UE and the IoT device, and to determine, based on a location request for the IoT device, location information of the UE bound to the IoT device, where the UE is located within a preset range of the IoT device, or the IoT device is located within a preset range of the UE.

In the embodiments of the present disclosure, the network function set may include one or more network functions on the network side, e.g., the network function set may include one or more of: an AMF, a SMF, a user plane function (UPF), a UDM, an AF, and a NEF.

In an embodiment, the IoT device may establish a connection with the UE within the preset range, e.g., a direct connection via Bluetooth, PC5, or a sidewalk link, etc.

In an embodiment, the UE may establish a connection with the IoT device within the preset range. For example, the UE may establish a connection with an IoT device after sending a registration request to the network function set and complete the registration.

In an embodiment, the UE sends a connection report to the network function set that may indicate the UE identifier of the UE and the device identifier of the IoT device for use by the network function set to establish a binding relationship between the UE identifier and the device identifier.

In some embodiments, the network function set may include: a first network function, a second network function, and a third network function.

The first network function is configured to: in response to receiving the location request for the IoT device from the third network function, send a location information obtaining request for the UE bound to the IoT device to the second network function, receive the location information of the UE sent by the second network function, and return the location information to the third network function.

The second network function is configured to: in response to receiving the location information obtaining request, from the first network function, for the UE, return the location information of the UE.

The third network function is configured to: send the location request for the IoT device to the first network function, and receive the location information of the UE returned by the first network function.

In the embodiments of the present disclosure, the first network function may be a UDM, the second network function may be an AMF associated with the UE, and the third network function may be an AF.

In an embodiment, the first network function may receive a binding relationship update request sent by the second network function based on the connection report, and establish a binding relationship between the UE and the IoT device based on the UE identifier and the device identifier as indicated by the binding relationship update request.

In an embodiment, the first network function receives a location request for the IoT device sent by the third network function, for example, receives the location request sent by the third network function via the NEF, and determines a UE bound to the IoT device to be located based on the device identifier and the binding relationship as indicated in the location request.

In an embodiment, the first network function sends a location information obtaining request to the second network function associated with the UE bound to the IoT device, and receives the location information of the UE returned by the second network function. The first network function may return the location information of the UE to the third network function as location information of the IoT device to be located.

In an embodiment, the second network function, upon receiving the connection report of the UE, sends a binding relationship update request to the first network function based on the UE identifier and the device identifier as indicated by the connection report.

In an embodiment, the second network function, after receiving the location information obtaining request for the UE sent by the first network function, obtains the location information for the UE, for example, it may obtain a location report for the UE from the RAN. The second network function may return the location report to the first network function.

In an embodiment, the third network function sends to the first network function a location request for the IoT device to be located, the location request may carry the device identifier of the IoT device, and receives the location information of the UE bound to the IoT device returned by the first network function based on the location request.

An embodiment of the present disclosure provides a system and method for positioning an IoT device.

A system architecture for positioning the IoT device is shown in FIG. 7, where a UPF is a user plane function.

As shown in FIG. 8, the method includes the following steps 1 to 10.

At step 1, the UE sends a registration request to the AMF via the RAN, and the registration request includes registration parameters such as at least one of: a registration type, a SUCI or 5G-GUTI or PEI, a security parameter, and so on. The AMF may retrieve the access and mobility subscription data from the UDM and the selection subscription data from the SMF by using an access and mobility subscription data get request (Nudm_SDM_Get). The AMF creates a UE context for the UE after obtaining the access and mobility subscription data from the UDM. After the UE is authenticated and authorized, the AMF sends a registration accept (for example, including GUTI) to the UE to complete the UE registration.

At step 2, a direct connection can be established between the IoT device and the neighboring UE through 3GPP PC5 or sidelink, other 3GPP wireless connection technologies (such as 3GPP Passive IoT or Ambient IoT), Bluetooth, WIFI, RFID or wired. During/after the connection establishment, the UE obtains the device identifier (e.g., GPSI) of the IoT device.

At step 3, the UE sends a NAS message “connected IoT device report” to the AMF via the RAN indicating that the IoT device (e.g., the GPSI of the IoT device) is directly connected to the UE. The message includes the device identifier (GPSI).

At step 4, the AMF sends a binding relationship update request (Nudm_UECM_Update) to the UDM that may, for example, include the SUPI of the UE and the device identifier of the IoT device in order to update the subscription and binding relationship between the UE and the IoT device in the UDM.

a) Subscription of a neighboring UE: a connected IoT device, e.g., subscribe to the GPSI of the connected IoT device.

b) Subscription of a IoT device: a neighboring UE, e.g., subscription to the SUPI or the GPSI of the neighboring UE. The mapping between the SUPI of the UE and the GPSI of the UE can be performed in the UDM.

The binding relationship between the IoT device and the neighboring UE is established in the UDM.

At step 5, the AF requests the location information of the IoT device from the UDM via the NEF, and the request contains the device identifier of the IoT device such as a GPSI.

At step 6, the UDM requests the location of the neighboring UE from the AMF via the UE identifier (e.g., a GPSI and/or a SUPI) based on the recorded binding relationship between the IoT device and the neighboring UE.

At step 7, the AMF sends a location report control message (e.g., including a UE ID, a report type, and a location report level) to the RAN. The UE ID may be a GUTI of the neighboring UE. The location report level may indicate the TAI and the cell identity. The report type indicates that the message is intended to trigger a single independent report about the identity of the cell currently serving the UE.

At step 8, the RAN sends a location report message to inform the AMF of the location information (e.g. TAI+cell identity) of the neighboring UE.

At step 9, the AMF sends the location report with the location (TAI+cell identity) of the neighboring UE to the UDM.

At step 10, the UDM sends the location (TAI+cell identity) of the neighboring UE received in step 9 as the approximate location of the IoT device to the AF via the NEF.

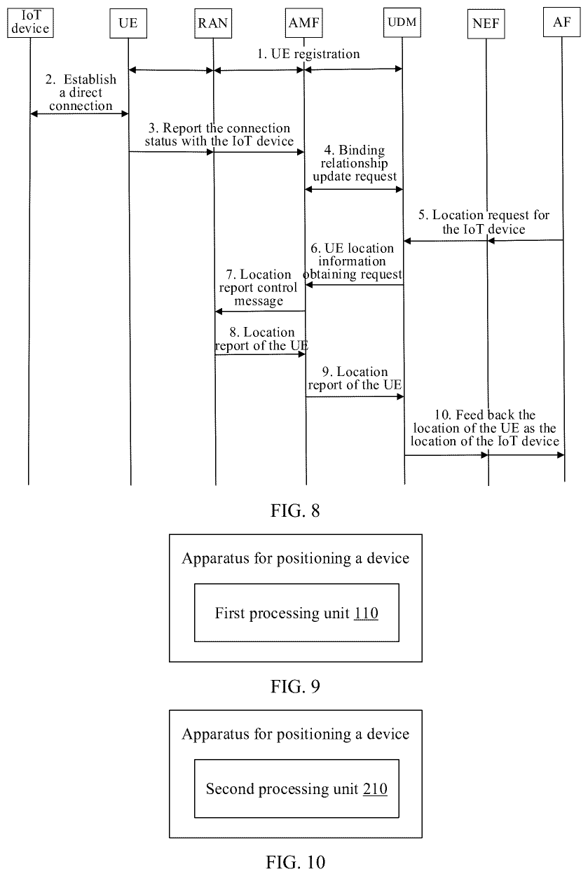

As shown in FIG. 9, an embodiment of the present disclosure provides an apparatus for positioning a device, which is applied to a first network function and includes a first processing unit 110.

The first processing unit is configured to: in response to receiving a location request for an internet of things (IoT) device, return location information of a user equipment (UE) bound to the IoT device, where the UE is located within a preset range of the IoT device, or the IoT device is located within a preset range of the UE.

In some embodiments, the first processing unit 110 is configured to:
determine a device identifier of the IoT device indicated by the location request;
obtain the location information of the UE bound to the IoT device as indicated by a binding relationship corresponding to the device identifier; and
return the location information.

In some embodiments, the first processing unit 110 is configured to:
determine, based on the binding relationship corresponding to the device identifier, the UE bound to the IoT device;
send a location information obtaining request to a second network function associated with the UE;
obtain a location report of the UE from the second network function; and
determine, based on the location report, the location information of the UE.

In some embodiments, the location report includes: a tracking area identity (TAI) corresponding to the UE, or a cell identity corresponding to the UE.

In some embodiments, the apparatus further includes a binding unit.

The binding unit is configured to: receive a binding relationship update request from the second network function associated with the UE; and bind the IoT device and the UE as indicated by the binding relationship update request.

In some embodiments, the binding relationship update request includes: a generic public subscription identifier (GPSI) or a subscriber permanent identifier (SUPI) of the UE, and a GPSI of the IoT device.

As shown in FIG. 10, an embodiment of the present disclosure provides an apparatus for positioning a device, which is applied to a second network function and includes a second processing unit 210.

The second processing unit 210 is configured to: in response to receiving a location information obtaining request, from a first network function, for a UE bound to an internet of things (IoT) device to be located, return location information of the UE, where the UE is located within a preset range of the IoT device, or the IoT device is located within a preset range of the UE.

In some embodiments, the location information obtaining request indicates at least a UE identifier of the UE bound to the IoT device to be located.

In some embodiments, the second processing unit 210 is configured to:
send a location report control message of the UE to a radio access network (RAN);
receive a location report of the UE returned by the RAN based on the location report control message; and
return the location report.

In some embodiments, the location report includes: a tracking area identity (TAI) corresponding to the UE, or a cell identity corresponding to the UE.

In some embodiments, the location report control message indicates at least one of that: a UE identifier of the UE; the location report is an independent location report indicating a cell in which the UE is located; or the location report includes at least one of: a TAI corresponding to the UE, or a cell identity corresponding to the UE.

In some embodiments, the apparatus further includes a processing unit.

The processing unit is configured to: in response to receiving a registration request for the UE, register the UE; receive a connection report sent by the registered UE, where the connection report indicates at least a device identifier of the IoT device with which the registered UE establishes a connection; and send, based on the connection report, a binding relationship update request indicating the registered UE and the IoT device to the first network function.

In some embodiments, the binding relationship update request includes: a generic public subscription identifier (GPSI) or a subscriber permanent identifier (SUPI) of the registered UE, and a GPSI of the IoT device.

As shown in FIG. 11, an embodiment of the present disclosure provides an apparatus for positioning a device, which is applied to a third network function and includes a third processing unit 310.

The third processing unit 310 is configured to: send a location request for an internet of things (IoT) device, and receive location information of a user equipment (UE) bound to the IoT device returned by a first network function, where the UE is located within a preset range of the IoT device, or the IoT device is located within a preset range of the UE.

In some embodiments, the third processing unit 310 is configured to: send, by a network exposure function (NEF), the location request for the IoT device to the first network function.

In some embodiments, the third processing unit 310 is configured to: receive, by the NEF, the location information of the UE bound to the IoT device returned by the first network function.

In some embodiments, the location information includes at least one of: a TAI corresponding to the UE, or a cell identity corresponding to the UE.

An embodiment of the present disclosure provides a communication device, including:
a memory storing instructions executable by a processor; and
a processor connected to the memory;
where the processor is configured to perform the method for positioning the device in any one of the embodiments.

The processor may include various types of storage medium that are non-transitory computer storage medium capable of continuing to memorize information stored thereon after the user device is powered down.

Herein, the communication device includes a terminal or a network element, which can be any one of the first to fourth network elements.

The processor may be connected with the memory through a bus or the like for reading the executable programs stored on the memory, for example, at least one of the methods shown in FIGS. 2 to 6, and FIG. 8.

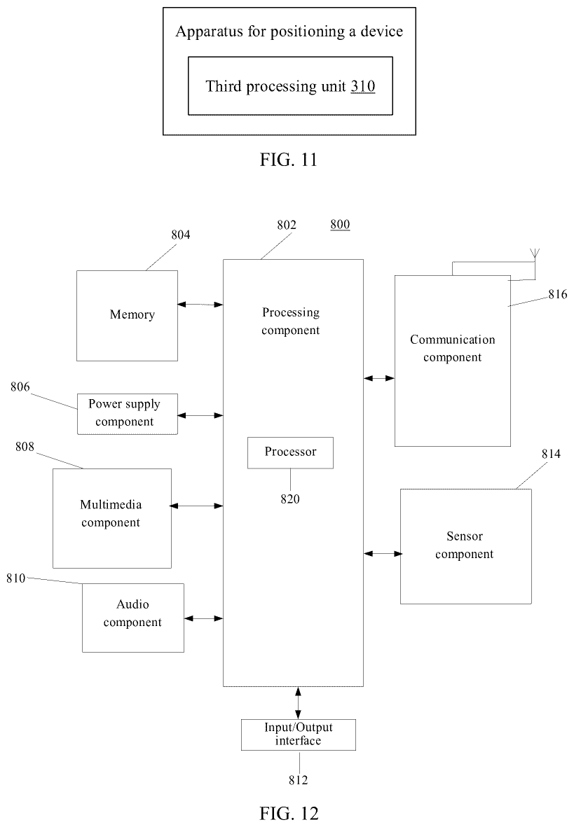

FIG. 12 is a block diagram illustrating a terminal according to an embodiment. For example, the terminal 800 may be a mobile phone, a computer, a digital broadcast UE, a message transmitting and receiving device, a game console, a tablet device, a medical device, a fitness device and a personal digital assistant and so on.

As shown in FIG. 12, the terminal 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls overall operations of the terminal 800, such as operations associated with display, phone calls, data communications, camera operations, and recording operations. The processing component 802 may include one or more processors 820 to execute instructions to complete all or a part of the steps of the above methods. In addition, the processing component 802 may include one or more modules which facilitate the interaction between the processing component 802 and other components. For example, the processing component 802 may include a multimedia module to facilitate the interaction between the multimedia component 808 and the processing component 802.

The memory 804 is to store various types of data to support the operation of the terminal 800. Examples of such data include instructions for any application or method operated on the terminal 800, contact data, phonebook data, messages, pictures, videos, and so on. The memory 804 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power supply component 806 supplies power for different components of the terminal 800. The power supply component 806 can include a power supply management system, one or more power supplies, and other components associated with generating, managing and distributing power for the terminal 800.

The multimedia component 808 includes a screen providing an output interface between the terminal 800 and a user. In some embodiments, the screen may include a liquid crystal display (LCD) and/or a touch panel (TP). If the screen includes a touch panel, the screen may be implemented as a touch screen for receiving an input signal from a user. The touch panel may include one or more touch sensors for sensing a touch, a slide and a gesture on the touch panel. The touch sensor may not only sense a boundary of a touching or sliding movement, but also detect duration and pressure related to the touching or sliding operation. In some examples, the multimedia component 808 may include a front camera and/or a rear camera. The front camera and/or rear camera may receive external multimedia data when the terminal 800 is in an operating mode, such as a photographing mode or a video mode. Each of the front camera and the rear camera may be a fixed optical lens system or be of a focal length and a capability of an optical zoom.

The audio component 810 is configured to output and/or input an audio signal. For example, the audio component 810 includes a microphone (MIC). When the terminal 800 is in an operating mode, such as a call mode, a record mode and a voice recognition mode, the microphone is to receive an external audio signal. The received audio signal may be further stored in the memory 804 or sent via the communication component 816. In some examples, the audio component 810 also includes a speaker for outputting an audio signal.

The I/O interface 812 may provide an interface between the processing component 802 and peripheral interface modules. The above peripheral interface modules may include a keyboard, a click wheel, buttons and so on. Such buttons may include but not limited to: a home button, a volume button, a start button and a lock button.

The sensor component 814 includes one or more sensors to provide status assessments of various aspects for the terminal 800. For example, the sensor component 814 may detect an on/off state of the terminal 800 and a relative location of components. For example, the components are a display and a keypad of the terminal 800. The sensor component 814 may also detect a position change of the terminal 800 or a component of the terminal 800, presence or absence of a touch between a user and the terminal 800, an orientation or acceleration/deceleration of the terminal 800, and a temperature change of the terminal 800. The sensor component 814 may include a proximity sensor for detecting the existence of a nearby object without any physical touch. The sensor component 814 may also include a Complementary Metal-Oxide-Semiconductor (CMOS) or Charged Coupled Device (CCD) image sensor applied in an imaging application. In some examples, the sensor component 814 may also include an acceleration sensor, a gyro sensor, a magnetic sensor, a pressure sensor, or a temperature sensor.

The communication component 816 is to facilitate wired or wireless communication between the terminal 800 and other devices. The terminal 800 can access a wireless network based on a communication standard, such as Wi-Fi, 2G or 3G, or a combination thereof. In examples, the communication component 816 receives a broadcast signal or broadcast related information from an external broadcast management system via a broadcast channel. In examples, the communication component 816 may also include a Near Field Communication (NFC) module to facilitate short-range communications. For example, the NFC module may be implemented based on a radio frequency identification (RFID) technology, an infrared data association (IrDA) technology, an ultra wide band (UWB) technology, a bluetooth (BT) technology and other technologies.

In an example, the terminal 800 may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors or other electronic elements, for executing the method in any one of the above examples.

In an example, a non-transitory computer readable storage medium including instructions, such as the memory 804 including instructions, is also provided. The above instructions may be executed by the processor 820 of the terminal 800 to complete the above method. For example, the non-transitory computer readable storage medium may be a read-only memory (ROM), a random access memory (RAM), a CD-ROM, a magnetic tape, a floppy disk and an optical data storage device, etc.

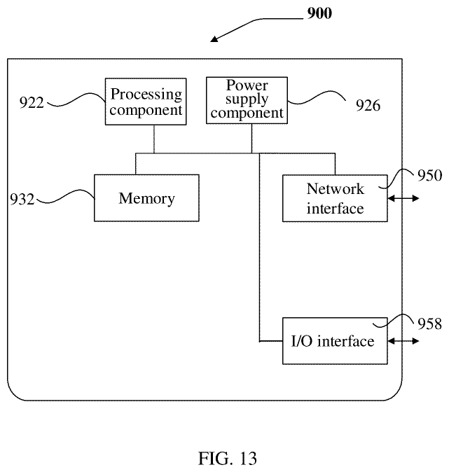

FIG. 13 is a structural schematic diagram illustrating a communication device 900 according to an embodiment of the present disclosure. For example, the communication device 900 may be provided as a network device. The communication device 900 may be a base station.

Referring to FIG. 13, the device communication 900 includes a processing component 922, which further includes one or more processors, and memory resources represented by a memory 932 for storing instructions, such as an application program, that may be executed by the processing component 922. The application program stored in the memory 932 may include one or more modules each corresponding to a set of instructions. In addition, the processing component 922 is configured to execute the instructions to perform the method as shown in any one of FIGS. 2 to 6, and FIG. 8.

The communication device 900 may further include: a power supply component 926, configured to manage power supply of the communication device 900, a wired or wireless network interface 950, configured to connect the communication device 900 to a network, and an input/output (I/O) interface 958. The communication device 900 may operate an operating system based on an operating system stored in the memory 932, such as Windows Server™, Mac OS X™, Unix™, Linux™, FreeBSD™ or the like.

According to the technical solution of the embodiments of the present disclosure, in response to the location request for the IoT device being received, the location information of the UE bound to the IoT device is returned, where the UE is located within a preset range of the IoT device. In this way, when the IoT device needs to be located, the location information of the UE bound to the IoT device is obtained and provided and the UE is located in a neighboring location of the IoT device, so that the location of the UE can be regarded as an approximate location of the IoT device, thus the tracking or positioning capability for the IoT device is improved. Furthermore, obtaining the location information of the UE is more convenient, the resource consumption for positioning the IoT device can be reduced, and by binding the UE and the IoT device, the positioning management capability for one or more IoT devices can be improved.

Other embodiments of the present disclosure will be readily apparent to those skilled in the art after considering the specification and practicing the contents disclosed herein. The present disclosure is intended to cover any variations, uses, modification or adaptations of the present disclosure that follow the general principles thereof and include common knowledge or conventional technical means in the art that are not disclosed in the present disclosure. The specification and examples are to be regarded as illustrative only. The true scope and spirit of the present disclosure are pointed out by the following claims.

It is to be understood that the present disclosure is not limited to the precise construction described herein and shown in the drawings, and that various modifications and changes may be made without departing from the scope thereof. The scope of the present disclosure is to be limited only by the appended claims.

1. A method for positioning a device, performed by a first network function and comprising:
in response to receiving a location request for an internet of things (IoT) device, returning location information of a user equipment (UE) bound to the IoT device, wherein the UE is located within a preset range of the IoT device, or the IoT device is located within a preset range of the UE.

2. The method of claim 1, wherein returning the location information of the UE bound to the IoT device comprises:
determining a device identifier of the IoT device indicated by the location request;
obtaining the location information of the UE bound to the IoT device as indicated by a binding relationship corresponding to the device identifier; and
returning the location information.

3. The method of claim 2, wherein obtaining the location information of the UE bound to the IoT device as indicated by the binding relationship corresponding to the device identifier comprises:
determining, based on the binding relationship corresponding to the device identifier, the UE bound to the IoT device;
sending a location information obtaining request to a second network function associated with the UE;
obtaining a location report of the UE from the second network function; and
determining, based on the location report, the location information of the UE.

4. The method of claim 3, wherein the location report comprises at least one of:
a tracking area identity (TAI) corresponding to the UE, or a cell identity corresponding to the UE.

5. The method of claim 2, wherein the location request for the IoT device comprises: the location request for the IoT device from a third network function;
wherein returning the location information comprises:
returning the location information to the third network function.

6. The method of claim 2, further comprising:
receive a binding relationship update request from the second network function associated with the UE; and
binding the IoT device and the UE as indicated by the binding relationship update request.

7. The method of claim 6, wherein the binding relationship update request comprises:
a generic public subscription identifier (GPSI) or a subscriber permanent identifier (SUPI) of the UE, and a GPSI of the IoT device.

8. A method for positioning a device, performed by a second network function and comprising:
in response to receiving a location information obtaining request, from a first network function, for a user equipment (UE) bound to an internet of things (IoT) device to be located, returning location information of the UE, wherein the UE is located within a preset range of the IoT device, or the IoT device is located within a preset range of the UE.

9. The method of claim 8, wherein the location information obtaining request indicates at least a UE identifier of the UE bound to the IoT device to be located.

10. The method of claim 8, wherein returning the location information of the UE comprises:
sending a location report control message of the UE to a radio access network (RAN);
receiving a location report of the UE returned by the RAN based on the location report control message; and
returning the location report.

11. The method of claim 10, wherein the location report comprises at least one of:
a tracking area identity (TAI) corresponding to the UE, or a cell identity corresponding to the UE.

12. The method of claim 10, wherein the location report control message indicates at least one of:
a UE identifier;
the location report being an independent location report indicating a cell in which the UE is located; or
the location report comprising at least one of: a TAI corresponding to the UE, or a cell identity corresponding to the UE.

13. The method of claim 8, further comprising:
in response to receiving a registration request for the UE, registering the UE;
receiving a connection report sent by the registered UE, wherein the connection report indicates at least a device identifier of the IoT device with which the registered UE establishes a connection; and
sending, based on the connection report, a binding relationship update request indicating the registered UE and the IoT device to a first network function.

14. (canceled)

15. A method for positioning a device, performed by a third network function and comprising:
sending a location request for an internet of things (IoT) device, and receiving location information of a user equipment (UE) bound to the IoT device returned by a first network function, wherein the UE is located within a preset range of the IoT device, or the IoT device is located within a preset range of the UE.

16. The method of claim 15, wherein sending the location request for the IoT device comprises:
sending, by a network exposure function (NEF), the location request for the IoT device to the first network function.

17. The method of claim 15, wherein receiving the location information of the UE bound to the IoT device returned by the first network function comprises:
receiving, by a NEF, the location information of the UE bound to the IoT device returned by the first network function.

18. The method of claim 15, wherein the location information comprises at least one of: a tracking area identity (TAI) corresponding to the UE, or a cell identity corresponding to the UE.

19.-23. (canceled)

24. A communication device, comprising:
a processor; and
a memory storing programs executable by the processor,
wherein the processor is configured to perform the method of claim 1.

25. (canceled)

26. A communication device, comprising:
a processor; and
a memory storing programs executable by the processor,
wherein the processor is configured to perform the method of claim 8.

27. A communication device, comprising:
a processor; and
a memory storing programs executable by the processor,
wherein the processor is configured to perform the method of claim 15.
